(19) United States
(12) Patent Application Publication
(10) Pub. No.: US 2008/0289193 A1
(43) Pub. Date: Nov. 27, 2008

(54) Safety Guard For A Hand-Guided Tool

(76) Inventors: Justus Lamprecht, Dusslingen (DE); Joachim Schadow, Dettenhausen (DE); Sinisa Andrasic, Schoenaich (DE); Cornelius Boeck, Kirchheim (DE)

Correspondence Address: MICHAEL J. STRIKER, 103 EAST NECK ROAD, HUNTINGTON, NY, 11743, US

(21) Appl. No.: 11/909,995

(22) PCT Filed: Nov. 8, 2006
(86) PCT No.: PCT/EP2006/068207

§ 371 Date: Sep. 28, 2007

(30) Foreign Application Priority Data
Dec. 27, 2005 (DE) 10 2005 062 458.8

(51) Int. Cl. B26B 29/00

(52) U.S. Cl. 30/286

(57) ABSTRACT

The invention relates to a protective hood for a portable tool with a rotary tool, having an axial wall for covering regions of the rotary tool. It is proposed that the axial wall (3) have wall regions (4) which are axially offset from one another and are connected to one another, in particular in one piece. Furthermore, a portable tool is proposed which has such a protective hood (1).

The invention relates to a safety guard for a hand-guided power tool as recited in the preamble to claim 1. The invention also relates to a hand-guided power tool equipped with such a safety guard.

### PRIOR ART

Hand-guided power tools with rotating tools such as angle grinders enjoy ubiquitous use in an extremely wide variety of fields. Because of the large number of rotating tools that are available, this type of hand-guided power tool can be used for a myriad of purposes and because of its performance, has become very popular. Particularly with the use of disk-shaped rotating tools, such hand-guided power tools must be provided with safety guards. Not only do these guards keep sparks and abraded particles of material away from the operator, but they also prevent parts, which are catapulted outward when a rotating tool shatters, from reaching the vicinity of the operator and causing injury. Such safety guards are known. They have a coverage region in relation to the rotating tool and in another region, leave the rotating tool uncovered so that in the latter region, the rotating tool can be placed against the work piece that is to be machined. In order to be able to effectively fulfill their task of protecting the operator and surrounding areas and in order to offer sufficient protection from shattering rotating tools that release a large amount of energy, these safety guards are manufactured out of a strong, usually tough, thick-walled material. As a rule, they are embodied in the form of a strong component composed of shaped sheet metal.

Due to their thick-materialed, strong design, these safety guards have the disadvantage of being relatively heavy and consuming a large amount of material.

### ADVANTAGES OF THE INVENTION

The present invention has the advantage over the prior art that the axial wall has wall regions that are axially offset from one another and are connected, in particular integrally joined, to one another. This embodiment provides a comparatively high strength even with a low material thickness, thus representing a savings in material and weight.

In a preferred embodiment, a plurality of the wall regions are of equal area and/or geometry. The expression “of equal area” means that the individual wall regions have essentially the same area; the expression “of equal geometry” means that the wall regions have similar angles.

In another preferred embodiment, the wall regions have radially extending abutting surfaces. This means that the above-mentioned wall regions border one another so that these abutting regions each extend along a radius in relation to the outer circumference of the safety guard.

In a particularly preferred embodiment, the abutting surfaces are embodied in the form of steps. A stepped embodiment of the abutting surfaces between the individual wall regions results in a pronounced material rigidity with the same material expense or, with at least the same rigidity, results in a reduced material expenditure and therefore a savings in cost and weight. At the same time, the abutting zones embodied in the form of steps result in the fact that material particles or parts of shattered rotating tools are slowed in their trajectories inside the safety guard and are deflected so that it is not possible for them to burst through the safety guard thanks to the powerful prior energy loss that has already occurred.

In a particularly preferred embodiment, the steps constitute reinforcing steps. This particular embodiment of the steps with regard to their material thickness and the course of the step from one wall surface to the next makes it possible to produce an effect that strengthens and stiffens the structure of the safety guard.

In another embodiment, a skirt adjoins the axial wall and is preferably integrally joined to it. This means that the axial wall is formed onto the skirt at an angle of essentially 900 in the axial direction; preferably, the axial wall and skirt are comprised of a single piece.

In another embodiment, the skirt has a circumference surface that extends spaced the same coaxial distance apart from the rotation axis of the rotating tool. This means that the axially offset embodiment of the wall regions of the axial wall does not extend into the skirt or only extends into it by an insignificant amount; instead, the circumference surface is essentially embodied as smooth. In connection with the axially offset embodiment of the individual wall regions, this achieves an even better stiffening of the safety guard.

In another embodiment of the invention, the safety guard has a rotating tool clearance region that extends essentially along a section embodied in the form of a rolled edge. The expression “rotating tool clearance region” is understood to be the region in which the rotating tool is not covered by the safety guard, but instead rotates freely for its working purpose and is placed against the work piece to be machined. The embodiment of at least parts of the rotating tool clearance region in the form of a rolled edge results in a particularly stable, rigid construction.

In another embodiment of the invention, the safety guard has a clamping mechanism for fastening it to the hand-guided power tool in a removable fashion. Such a clamping device makes it possible to detachably fasten the safety guard to the hand-guided power tool.

The invention also includes a hand-guided power tool equipped with a safety guard according to one or more of the preceding claims. Thanks to the structural advantages cited above, hand-guided power tools equipped with a safety guard according to the invention enjoy weight savings and are more versatile and flexible in use and in this connection, are also less fatiguing for the operator.

The invention will be explained in greater detail below in conjunction with the drawings.

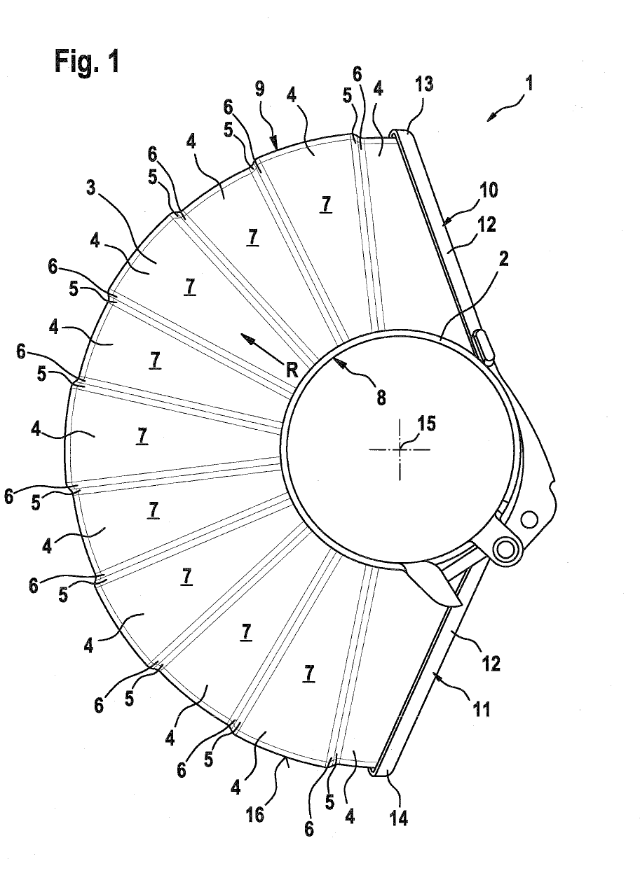

FIG. 1 is a top view of a safety guard,

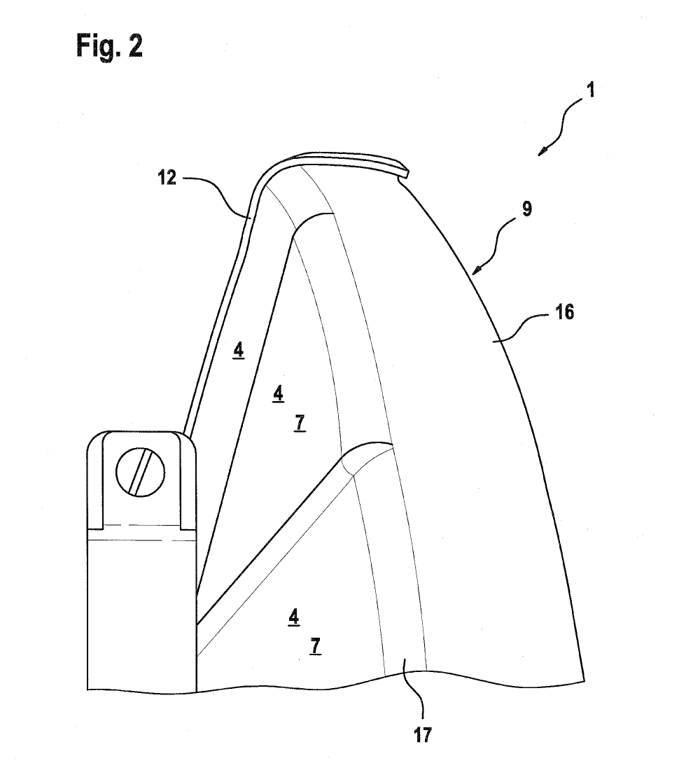

FIG. 2 is a partial, perspective view of a safety guard.

FIG. 1 depicts a safety guard 1 for a hand-guided power tool that is not shown. The safety guard has an axial wall 3 extending out from essentially one side of a clamping ring 2. This axial wall extends out from the clamping ring essentially in the radial direction R, thus forming wall regions 4 that are axially offset from one another. Between the individual wall regions 4 there are abutting zones 5 embodied in the form of steps 6. The wall regions 4, viewed in the axial direction, are situated in alternating raised and recessed positions and are integrally joined to one another here by means of the abutting zones 5 embodied in the form of steps 6. In lieu of an integral embodiment (for example, comprised of a single stamped component), it is naturally also possible to join individual wall regions 4 to one another by means of welding, for example, or another joining technique, thus producing the embodiment described above. In particular, joining individual wall regions 4 by means of welding results in an especially favorable stiffening with a predetermined material thickness, but this makes the production somewhat more complex. A plurality of the wall regions 4 each comprise a respective annular segment 7; each annular segment 7 is bounded at its inner circumference by a collar 8 supported against the clamping ring 2 and bounded at its outer circumference by a skirt 9. The wall regions 4 that occupy a first end region 10 and second end region 11 of the axial wall 3 are embodied so that toward the first end region, they have an abutting zone 5 embodied in the form of a step 6 oriented toward the wall region 4, which is embodied as an annular segment 7 and is situated adjacent to it on the respective inside, but toward the second end region, they have a rolled edge 12. The rolled edge 12 is integrally joined to the axial wall 3. The wall regions 4 situated at the first end region 10 and second end region 11 are not embodied in the form of annular segments, but are instead embodied so that their inner circumferences adjoin the outer circumference of the clamping ring; connecting the first end point 13 of the first end region 10 to the second end point 14 of the second end region 11 through the center axis 15 of the clamping ring 2 yields a 180° coverage of a rotating tool, not shown, thus forming a semicircle with a circumference surface 16 of the skirt 9, delimited by an imaginary connection of the first end region 10 and the second end region 11, extending through the center axis 15. The embodiment in the form of annular segments 7 of the axial wall 3, in connection with the steps 6, produces a significant stiffening of the axial wall 3 in comparison to a flat embodiment. This effect is even more pronounced, however, due to a once again planar offset between the respective outer wall regions 4 and the placement of a respective rolled edge 12 in both the first end region 10 and second end region 11 of the axial wall 3.

Depending on the design of the individual wall regions 4 and steps 6, particularly with regard to the material thickness and degree of stiffening (planar offset), it is possible to achieve various degrees of stiffening of the axial wall 3.

FIG. 2 is a partial perspective view of the safety guard 1 with the second end region 11 and the rolled edge 12 situated along its periphery. In an angular region 17, the individual wall regions 4, in particular the annular segments 7, extend into the circumference surface 16 of the skirt 9 in such a way that they are spaced a uniform coaxial distance apart from the rotation axis of the rotating tool, not shown; their above-described axial offset therefore ends in the angular region 17 and does not extend into the circumference surface 16. Once again, this contributes to a significant stiffening of the structure.

What is claimed is:

1. A safety guard for a hand-guided power tool equipped with a rotating tool, having an axial wall (3) for covering the rotating tool in some regions,
wherein the axial wall (3) has wall regions (4) that are axially offset from one another and are connected, in particular integrally joined, to one another.

2. The safety guard as recited in claim 1,
wherein a plurality of wall regions (4) are of equal area and/or geometry.

3. The safety guard as recited in claim 1,
wherein the wall regions (4) have radially extending abutting surfaces.

4. The safety guard as recited in claim 1,
wherein the abutting surfaces have abutting zones (5) embodied in the form of steps (6).

5. The safety guard as recited in claim 1,
wherein the steps (6) constitute stiffening steps.

6. The safety guard as recited in claim 1,
wherein the axial wall (3) adjoins a skirt (9), preferably in an integral fashion.

7. The safety guard as recited in claim 1,
wherein the skirt (9) has a circumference surface (16) that extends with a uniform coaxial distance from the rotation axis of the rotating tool.

8. The safety guard as recited in claim 1,
wherein the safety guard (1) has a rotation tool clearance region that is embodied in the form of a rolled edge (12) at least along one section.

9. The safety guard as recited in claim 1,
wherein the safety guard (1) has a clamping device for detachably fastening it to the hand-guided power tool.

10. A hand-power tool equipped with a safety guard (1) as recited in claim 1.
